(19) United States
(12) Patent Application Publication
(10) Pub. No.: US 2026/0264070 A1
(43) Pub. Date: Sep. 10, 2026

(54) Methods for Releasing at Least a Portion of a Halide From a Surface

(71) Applicant: Chevron Phillips Chemical Company LP, The Woodlands, TX (US)

(72) Inventors: Gabriela D. ALVEZ-MANOLI, Kingwood, TX (US); Joseph J. BERGMEISTER, Kingwood, TX (US); Spencer J. CAREY, Kingwood, TX (US); Donald A. STERN, Kingwood, TX (US)

(21) Appl. No.: 19/165,477

(22) PCT Filed: Mar. 22, 2024
(86) PCT No.: PCT/US2024/021135

§ 371 Date: Sep. 15, 2025

Related U.S. Application Data
(60) Provisional application No. 63/491,703, filed on Mar. 22, 2023.
(60) Provisional application No. 63/493,418, filed on Mar. 31, 2023.
(60) Provisional application No. 63/568,189, filed on Mar. 21, 2024.

(51) Int. Cl. B01J 38/42; B01J 38/10

(52) U.S. Cl. CPC B01J 38/42; B01J 38/10

(57) ABSTRACT

Contacting an interior surface, optionally metal, of a petrochemical or refining process vessel with a halide or a halide-containing compound, wherein, as a result of the contracting, at least a portion of the halide is coupled to the interior surface; and releasing at least the portion of the halide coupled to the interior surface via contact thereof with hydrogen.

### FIELD OF THE DISCLOSURE

This disclosure relates to methods of releasing at least a portion of a halide from a surface of a refining or petrochemical process vessel after the surface has been exposed to halide, for example during regenerating spent aromatization catalysts.

### BACKGROUND

In industrial chemical processing plants and petroleum refineries, there are many types of process vessel, tanks, reactors, and the like that are made of metal and have an interior surface that is in contact with process fluids and reactants. In various petrochemical and refining processes, one or more of these interior surfaces may come into contact with a halide or a compound containing a halide. When halides are present, the corrosive nature of halides, especially chlorides and fluorides, may cause damage to the interior surface such as pitting, stress corrosion cracking, and general corrosion in metallic materials.

An example of a chemical process employing halides is aromatization of linear, or aliphatic, hydrocarbons into aromatic compounds such as benzene, toluene, and xylene through a series of chemical reactions. The aromatization process typically occurs in the presence of an aromatization catalyst. Aromatization catalysts can be regenerated with processes that include chlorination, oxidation, and fluorination. During the regeneration, the spent catalyst is typically contacted with chlorine gas followed by a burn step to remove the coke and re-disperse the metal, such as platinum. During contacting, chlorine and/or fluorine can be adsorbed on the interior surface of the reactor vessel, particularly those reactors having metal, such as stainless steel. The adsorbed chloride and/or fluoride can react with the metallurgy to cause pitting and cracking, and eventually result in a vessel failure. This adsorbed chloride and/or fluoride can be particularly destructive when vessels are opened to the atmosphere during maintenance and exposed to moisture present in air. Thus, there is a need to minimize vessel damage after chloride and/or fluoride is adsorbed on the interior surface of a vessel during use thereof, e.g., during catalyst regeneration.

### SUMMARY

Other technical features may be readily apparent to one skilled in the art from the following figures, descriptions and claims.

In some aspects, the techniques described herein relate to a method, comprising contacting a catalyst with a halide within a vessel having a surface wherein at least a portion of the halide is coupled to the surface; and regenerating the catalyst with a reducing fluid at, e.g., suitable conditions, to release the at least the portion of the halide coupled to the surface.

In some aspects, the techniques described herein relate to a method of removing all or a portion of a residual metal halide from a vessel wall surface, comprising contacting the vessel wall surface comprising a first amount of the residual metal halide with a reducing fluid at about 500° F. to about 1,300° F., and at least about 1 hour to form a halide gas, and removing at least a portion of a halide from the residual metal halide from the vessel wall surface to provide a second amount of the residual metal halide, wherein the second amount is less than the first amount.

In some aspects, the techniques described herein relate to a method, comprising contacting a hydrocarbon feed with an aromatization catalyst comprising a transition metal and a catalyst support under reforming conditions in a metal reactor to produce an aromatic product; performing contacting for a time period sufficient to form spent aromatization catalyst; stopping contacting with the hydrocarbon feed; stripping with hydrogen; purging with nitrogen; halogenating with a first halide a spent aromatization catalyst; purging with nitrogen; oxidating at a temperature less than or equal to about 400° F.; oxidating at a temperature greater than or equal to about 400° F. and less than or equal to about 1,000° F.; halogenating with a second halide the spent aromatization catalyst; purging with a gas comprising oxygen; cooling the metal reactor to less than or equal to 500° F.; purging with nitrogen; and reducing with a reducing fluid to remove a metal halide from a metal reactor wall surface.

In some aspects, the techniques described herein relate to a method, comprising contacting an interior surface, optionally metal, or an interior metal surface area of a reactor vessel or a reactor system with a halide or a halide-containing compound, wherein at least a portion of the halide is coupled to the interior surface; and releasing at least the portion of the halide coupled to the interior surface via contact with hydrogen.

In some aspects, the techniques described herein relate to a method of regenerating a spent catalyst comprising a transition metal and a catalyst support in a metal reactor, the method comprising (1) contacting the spent catalyst with a chlorine-containing stream comprising a chloride-containing compound to produce a chlorinated spent catalyst; (2) contacting the chlorinated spent catalyst with a decoking gas stream comprising oxygen to produce a de-coked catalyst; (3) contacting the de-coked catalyst with a fluorine-containing stream comprising a fluoride-containing compound to produce a regenerated catalyst, wherein the fluoride-containing compound comprises a hydrofluorocarbon (HFC), a chlorofluorocarbon (CFC), a hydrochlorofluorocarbon (HCFC), a fluorocarbon (FC), or a combination thereof, wherein the contacting (1), the contacting (2), or both yield a residual halide on an interior surface or interior surface area of the metal reactor, and (4) removing at least the portion of the residual halide via contact with hydrogen.

In some aspects, the techniques described herein relate to a method of regenerating a spent catalyst comprising a transition metal and a catalyst support in a metal reactor, the method comprising (1) contacting the spent catalyst with a chlorine-containing stream comprising a chloride-containing compound to produce a chlorinated spent catalyst; (2) contacting the chlorinated spent catalyst with a decoking gas stream comprising oxygen to produce a de-coked catalyst; (3) contacting the de-coked catalyst with a fluorine-containing stream comprising a fluoride-containing compound to produce a regenerated catalyst, wherein the fluoride-containing compound comprises a hydrofluorocarbon (HFC), a chlorofluorocarbon (CFC), a hydrochlorofluorocarbon (HCFC), fluorocarbon (FC), or a combination thereof; wherein the contacting (1), the contacting (2), or both yield a residual halide on an interior surface or interior surface area of the metal reactor, and (4) contacting the residual halide with hydrogen under conditions effective for the removal of at least a portion of the residual halide from the interior surface or the interior surface area.

### BRIEF DESCRIPTION OF THE DRAWINGS

For a more complete understanding of this disclosure, reference is now made to the following description, taken in conjunction with the accompanying drawings, in which:

FIG. 1 illustrates an exemplary schematic of an embodiment of a furnace, a vessel containing catalyst, and an absorber in fluid communication for, e.g., an aromatization process.

FIG. 2 illustrates an exemplary elevational, cross-sectional view of an embodiment of the vessel containing catalyst.

FIG. 3 is a plan, cross-sectional view of an embodiment of one or more scallops in the vessel containing catalyst.

FIG. 4 is a top, plan view of an embodiment of a reactor tube sectioned into four parts.

FIG. 5 is a top, plan view of an embodiment of a split part of the reactor tube that is positioned above a catalyst bed.

FIG. 6 is a top, plan view of an embodiment of a split part of the reactor tube that is positioned at about the same height as the catalyst bed.

FIG. 7 is a top, plan view of an embodiment of a split part of the reactor tube that is positioned below the catalyst bed.

### DETAILED DESCRIPTION

It is to be understood that the following disclosure describes aspects, features, structures, and/or functions of the disclosure. Exemplary components, arrangements, and configurations described below are provided merely as examples, and are not intended to limit the scope of the disclosure. Moreover, the exemplary components, arrangements, and configurations described below can be present in any flow-through, e.g., any element from one component, arrangement, or configuration can be used in any other component, arrangement, or configuration without departing from the scope of the disclosure.

Additionally, certain terms are used throughout the following description and claims to refer to particular components. As one skilled in the art will appreciate, the naming convention for the elements described herein is not intended to limit the scope of the claimed subject matter, unless otherwise specifically defined herein. Further, the naming convention used herein is not intended to distinguish between components that differ in name but not function.

The term “coupled” refers to physical or chemical absorption or adsorption, or a reaction, of a substance, such as an atom or compound, to form a halide, usually a metal halide.

The term “halide” refers to a halogen atom bearing a negative charge, and includes fluoride, chloride, bromide, iodide, and astatide, and may form a metal halide such as iron chloride, or a gas halide such as hydrogen chloride. As used herein, fluorine may be used interchangeably with fluoride and chlorine may be used interchangeably with chloride.

The term “halogen” has its usual meaning and, as the context allows, includes halides. Therefore, examples of halogens include fluorine, fluoride, chlorine, chloride, bromine, bromide, iodine, iodide, astatine, and astatide. Further, the use of the term “fluoride” and “chloride” when describing the catalyst components or catalyst composition such as weight percentage or mole percentage of these components, does not depend on their presence in the catalyst in any particular molecular or ionic form.

As used herein, the term “absorption” generally means a substance penetrating and/or binding in a material and the term “adsorption” generally means a substance binding on a surface of a material. The terms “absorption” and “adsorption” and their derivatives may be used interchangeably, and each term “absorption” and “adsorption” as used herein means the process of absorption and/or adsorption.

The term “stannide” refers to an intermetallic compound comprising tin and one or more other metals, and may be in the form of a coating. Examples of a stannide include FeₓSn_{y}, NiₓSn_{y}, or a combination thereof, and other stanides may also be present, such as MgₓSn_{y}, KₓSn_{y}, SrₓSn_{y}, LiₓRh_{y}Sn_{z}, MgₓRu_{y}Sn_{z}, and/or NbₓSn_{y}.

The term “and/or” refers to one or more of items in any combination in a list, such as “A and/or B” means “A, B, or the combination of A and B”.

In some embodiments, a method can include contacting an interior surface, optionally metal, of a petrochemical or refining process vessel with a halide or a halide-containing compound, wherein, as a result of the contracting, at least a portion of the halide is coupled to the interior surface; and releasing at least the portion of the halide coupled to the interior surface via contact thereof with hydrogen. The releasing can be achieved by contacting the interior surface having halide coupled thereto (e.g., a halided-surface or halided vessel surface) with hydrogen under conditions suitable and/or effective to remove all or a portion of the halide from the surface.

Examples of suitable petrochemical or refining process vessels having an interior surface that may come into contact with one or more halides or compounds containing a halide to form a halided-surface include storage tanks such as crude oil storage tanks, product tanks, and feedstock tanks; reaction vessels such as batch reactors, continuous stirred-tank reactors (CSTR), plug flow reactors, tubular reactors, and catalytic reactors including fixed and fluidized bed reactors; separation equipment such as distillation columns, absorbers, strippers, extractors, decanters, and centrifuges; heat exchangers such as shell and tube heat exchangers, plate heat exchangers, and air cooled head exchangers; pressure vessels such as autoclaves, pressure reactors, and gas holders; mixing equipment such as mixers, blenders, mixing tanks, and agitated tanks, and specialty vessels such as electrolyzers, crystallizers, and evaporators.

An interior surface can be contacted with a halogen to form a halided-surface during any suitable process involving use of a halide or a halide-containing compound, for example for use as a catalyst, a reactant, an intermediate, a product, or a by-product. For example, an interior surface can be contacted with a halogen to form a halided-surface during reactions involving halogenation, dehalogenation, dehydrohalogenation, or other halide-related or halide-catalyzed chemical transformations.

The contacting of hydrogen with the halided-surface may occur under conditions suitable and/or effective for the removal of all or a portion of the halide from the surface. The hydrogen may be in a reducing stream including about 10 mole percent (mol %) to about 100 mol % hydrogen, about 10 mol % to about 90 mol % hydrogen, and about 20 mol % to about 80 mol % hydrogen with the balance nitrogen. A reducing temperature can be in a range of from about 500° F. to about 1,300° F., alternatively from about 550° F. to about 1,200° F., or alternatively from about 600° F. to about 1,100° F.; a reducing pressure can be in a range of from about 1 bar to about 34 bar, about 1 bar to about 20 bar, or about 1.5 bar to about 20 bar; and a contact time can be in a range of from about 1 hour (h) to about 72 h, alternatively from about 2 h to about 48 h, or alternatively from about 2 h to about 24 h, or any suitable time for removal of the halide depending on, e.g., vessel type, flow rates, and resident time.

In some embodiments, the contacting of the interior surface with a halide or a halide-containing compound to form a halided-surface and the releasing at least the portion of the halide coupled to the interior surface via contact thereof with hydrogen occurs in the context of an aromatization process employing one or more aromatization catalysts comprising one or more halides. Without limiting the overall inventive aspects or subject matter disclosed and claimed herein, the remainder of the detailed description will relate to embodiments of aromatization processes.

In some embodiments, a method can include contacting a hydrocarbon feed with an aromatization catalyst including a transition metal and a catalyst support under reforming conditions in a metal reactor to produce an aromatic product. The catalyst can be used to facilitate the reaction. Prior to use, e.g., contacting with a hydrocarbon feed, the catalyst can include at least one metal of IUPAC Groups 8-11, at least one halide, and a support. Generally, the at least one metal can include platinum, the at least one halide can include chloride, fluoride, or a combination thereof, and the support can include a zeolite, an L-zeolite, a bound zeolite base, or a combination thereof. In some aspects, the support includes the bound zeolite base, such as a bound L-zeolite, or a bound barium ion-exchanged L-zeolite. In some other embodiments, the bound zeolite base can include a silica-bound K/L-zeolite. In some embodiments, the catalyst support can include (or can consist essentially of, or can consist of) a zeolite, an amorphous inorganic oxide, or any combination thereof. Generally, the catalyst support can include (or can consist essentially of, or can consist of) an L-zeolite, a Y-zeolite, a mordenite, an omega zeolite, and/or a beta zeolite, particularly a potassium L-zeolite or a barium ion-exchanged L-zeolite. In some aspects, the catalyst support can include (or can consist essentially of, or can consist of) a binder comprising alumina, silica, a mixed oxide thereof, or a mixture thereof.

In some embodiments, the catalyst can include a transition metal including a Group 8-11 transition metal. Generally, the transition metal can include (or can consist essentially of, or can consist of) platinum. Typically, the catalyst includes any weight percentage range of transition metal disclosed herein, for example, from about 0.1 wt. % to about 10 wt. %, or from about 0.3 wt. % to about 3 wt. %, transition metal.

In some aspects, the catalyst includes from about 0.3 wt. % to about 3 wt. %, from about 0.5 wt. % to about 2.5 wt. %, from about 0.5 wt. % to about 2 wt. %, or from about 0.7 wt. % to about 1.5 wt. % platinum; from about 0.1 wt. % to about 7.0 wt. %, from about 0.2 wt. % to about 6.0 wt. %, from about 0.3 wt. % to about 5.0 wt. %, from about 0.4 wt. % to about 4.5 wt. %, from about 0.5 wt. % to about 4.0 wt. %, from about 0.6 wt. % to about 3.5 wt. %, from about 0.7 wt. % to about 3.0 wt. %, or from about 0.8 wt. % to about 2.5 wt. % chlorine; and from about 0.2 wt. % to about 1.5 wt. %, from about 0.25 wt. % to about 1.3 wt. %, from about 0.3 wt. % to about 1.1 wt. %, or from about 0.3 wt. % to about 1.0 wt. % fluorine; all based on a total weight of the supported, fresh catalyst, optionally reduced. In some embodiments, the catalyst includes from about 0.3 wt. % to about 3 wt. %, from about 0.5 wt. % to about 2.5 wt. %, from about 0.5 wt. % to about 2 wt. %, or from about 0.7 wt. % to about 1.5 wt. % platinum; from about 0.3 wt. % to about 1.5 wt. %, from about 0.4 wt. % to about 1.2 wt. %, or from about 0.5 wt. % to about 1.1 wt. % chlorine; and from about 0.2 wt. % to about 1.5 wt. %, from about 0.25 wt. % to about 1.3 wt %, from about 0.3 wt. % to about 1.1 wt. %, or from about 0.3 wt. % to about 1.0 wt. % fluorine; all based on a total weight of the supported, fresh catalyst, optionally reduced. In some aspects, the catalyst includes from about 0.3 wt. % to about 3 wt. %, from about 0.5 wt. % to about 2.5 wt. %, from about 0.5 wt. % to about 2 wt. %, or from about 0.7 wt. % to about 1.5 wt. % platinum; from about 1.5 wt. % to about 5 wt. %, from about 1.7 wt. % to about 4.5 wt. %, or from about 1.8 wt. % to about 4 wt. % chlorine; and from about 0.2 wt. % to about 1.5 wt. %, from about 0.25 wt. % to about 1.3 wt. %, from about 0.3 wt. % to about 1.1 wt. %, or from about 0.3 wt. % to about 1.0 wt. % fluorine; all based on a total weight of the supported, fresh catalyst, optionally reduced. Generally, the bound zeolite base comprises a silica-bound K/L-zeolite; the metal comprises platinum; and a weight ratio of chlorine:fluorine is in a range from about 0.5:1 to about 5:1. In some aspects, the catalyst can include (or can consist essentially of, or can consist of) platinum on a KL-zeolite.

After applying the chlorine, fluorine, or both, the catalyst can be reduced. The reducing gas can include about 20 mol % to about 100 mol %, about 25 mol % to about 90 mol %, or about 30 mol % to about 80 mol % hydrogen and the balance nitrogen. The catalyst is reduced in the same vessel as the contacting with hydrocarbons is performed. Sometimes, halide can elute from the fresh catalyst typically in the presence of gas flows and the eluted halide can accumulate on the interior surfaces of the vessel. After installation, the fresh catalyst can be contacted with a hydrocarbon and hydrogen feed can be performed for a period of time sufficient to form spent aromatization catalyst. Usually, the spent catalyst can include any weight percentage range of platinum disclosed herein, for example, from about 0.3 wt. % to about 3 wt. %, from about 0.5 wt. % to about 2.5 wt. %, from about 0.5 wt. % to about 2 wt. %, or from about 0.7 wt. % to about 1.5 wt. % platinum.

The spent aromatization catalyst can be regenerated by introducing a halide stream for some given period of time. In some aspects, during contacting the catalyst with one or more halogen-containing streams, the metal surfaces of the vessel and internal structures, such as scallops and reactor tubes, can become halided. Particularly in some aspects, prior to passing the reducing fluid, haliding a catalyst within a vessel in communication with a furnace can result in forming and/or depositing at least a portion of the residual amount of the metal halide on the interior surfaces of the vessel and internal structures. As an example, the vessel wall surface can react with a halogen during halogenation of the catalyst.

In some embodiments, methods of regenerating spent catalysts, such as spent aromatization catalysts, are undertaken. In some embodiments, the methods herein include contacting the spent catalyst with a chlorine-containing stream that includes a chlorine-containing compound to produce a chlorinated spent catalyst; contacting the chlorinated spent catalyst with a decoking gas stream including oxygen to produce a de-coked catalyst; and contacting the de-coked catalyst with a fluorine-containing stream including a fluorine-containing compound to produce a regenerated catalyst subject to being reduced. In some embodiments, the fluorine-containing compound includes a hydrofluorocarbon (HFC), a fluorocarbon (FC), a chlorofluorocarbon (CFC), a hydrochlorofluorocarbon (HCFC), or a combination thereof.

In some embodiments, a halogen-containing stream, such as a chlorine-containing stream or a fluorine-containing stream, also includes an inert gas, air, or a combination thereof. In some embodiments, the chlorination can be conducted at a temperature of about 75° F. to about 600° F., about 200° F. to about 550° F., or about 250° F. to about 450° F. Generally, the chlorination step can be conducted for a time period in any range of chlorination time periods disclosed herein, for example, from about 0.1 hour to about 72 hours, from about 0.1 hour to about 60 hours, from about 0.1 to about 48 hours, from about 0.1 to about 12 hours, or from about 0.1 to about 8 hours. The contact time can vary depending on the particular circumstances, such as the size of the reactor, the flow rates, resident times, targeted amount of chlorine absorbed on the catalyst, or other factors. Generally, contacting will be conducted for a suitable time for halide to be absorbed on the catalyst.

The amount of chlorine absorbed on the regenerated catalyst can be about 0.3 wt. % to about 1.5 wt. %, about 0.4 wt. % to about 1.2 wt. %, or about 0.5 wt. % to about 1.1 wt. %, although in some embodiments chlorination levels can be higher as disclosed herein for fresh catalyst. Afterwards, oxidation can be conducted at a temperature of about 500° F. to about 1,000° F., about 600° F. to about 950° F., or about 650° F. to about 900° F. An inert gas and air (including oxygen) may be present at a volume ratio of about 3:1 to about 30:1 (inert gas:air). The amount of oxygen in the fluorine-containing gas, including a fluorine-containing compound, may be about 1 mol % to about 21 mol %, about 1 mol % to about 15 mol %, or about 1 mol % to about 10 mol %. In some embodiments, the fluorination can be conducted at a temperature of about 300° F. to about 1,100° F., about 300° F. to about 1,000° F., or about 300° F. to about 950° F. The amount of fluorine absorbed on the regenerated catalyst can be about 0.1 wt. % to about 1.5 wt %, about 0.15 wt. % to about 1.3 wt. %, or about 0.2 wt % to about 1.2 wt. %. A fluorine-containing compound may be present in a fluorine-containing stream at an amount effective to impart a concentration of fluorine in the fluorine-containing stream of from about 0.1 mole percent (mol %) to about 3.0 mol %, about 0.12 mol % to about 2.0 mol %, or about 0.15 mol % to about 1.8 mol %. The chlorine and fluorine can be added at a targeted time and concentration to get to the targeted chloride and fluoride for the reactivated catalyst. In some aspects, a concentration of halogen in the regenerated catalyst may be about 0.4 wt. % to about 3 wt. %.

In some embodiments, the chlorine-containing stream can include (or can consist essentially of, or can consist of) the chlorine-containing compound and any inert gas disclosed herein, for example, nitrogen. Generally, the chlorine-containing stream can include (or can consist essentially of, or can consist of) chlorine gas (Cl) and nitrogen. Generally, the amount of chlorine-containing compound in the chlorine-containing stream can be controlled to give a concentration of chlorine (Cl) for the required concentration on the catalyst, such as less than any maximum amount or in any range disclosed herein, for example, less than about 50,000 parts per million by volume (ppmv), in a range from about 5 to about 25,000 ppmv, in a range from about 10 to about 10,000 ppmv, in a range from about 50 to about 5,000 ppmv, or in a range from about 100 to about 1,000 ppmv. Sometimes, the chlorine-containing stream can be substantially free of oxygen-containing compounds and/or fluorine-containing compounds, for example, less than about 100 parts per million by weight (ppmw).

In some aspects, the chlorine-containing compound can include (or can consist essentially of, or can consist of) hydrochloric acid, chlorine gas (Cl), carbon tetrachloride, tetrachloroethylene, chlorobenzene, methyl chloride, methylene chloride, chloroform, allyl chloride, trichloroethylene, a chloramine, a chlorine oxide, a chlorine acid, chlorine dioxide, dichlorine monoxide, dichlorine heptoxide, chloric acid, perchloric acid, ammonium chloride, tetramethylammonium chloride, tetraethylammonium chloride, tetrapropylammonium chloride, tetrabutylammonium chloride, methyltriethylammonium chloride, or any combination thereof. In some alternative aspects, the chlorine-containing compound can include (or can consist essentially of, or can consist of) chlorine gas (Cl₂).

In some embodiments, the fluorine-containing stream can include (or can consist essentially of, or can consist of) (i) the fluorine-containing compound and any inert gas disclosed herein, for example, nitrogen, (ii) the fluorine-containing compound, any inert gas disclosed herein, and air, or (iii) the fluorine-containing compound and air; wherein when the fluorine-containing stream can include an inert gas and air, the inert gas and air may be present at a ratio of about 3:1 to about 20:1, or about 6:1, or the mole percent oxygen in the fluorine-containing stream can be about 1 mol % to about 21 mol %, about 1 mol % to about 15 mol %, or about 1 mol % to about 10 mol %.

In some aspects, the fluorine-containing stream, e.g., containing fluorine molecules, can be substantially free of oxygen-containing compounds and/or chlorine-containing compounds that do not include a fluorine atom, for example, less than about 100 ppmw, and the fluorination step can be conducted at (i) a fluorination temperature in any suitable fluorination temperature range. As an example, the temperature can range from about 68° F. to about 700° F., from about 100° F. to about 650° F., or from about 200° F. to about 600° F., (ii) a fluorination pressure of atmospheric pressure to about 15 bar, atmospheric pressure to about 10 bar, atmospheric pressure to about 9 bar, about 0.5 bar to about 10 bar, about 0.5 bar to about 9 bar, or about 0.5 bar to about 8 bar. Generally, the fluorination step can be conducted for a time period in any range of fluorination time periods disclosed herein, for example, from about 0.1 hours to about 96 hours, about 0.1 hours to about 72 hours, about 0.1 to about 48 hours, from about 0.1 to about 12 hours, or from about 0.1 to about 8 hours.

In some embodiments, the contacting of a de-coked catalyst with a halogen-containing stream occurs at a temperature of from about 75° F. to about 1,000° F., at a pressure of about 0.5 bar to about 10 bar, for a time period of from about 0.1 hours to about 48 hours, or a combination thereof. In some embodiments, the methods also include recovering at least a portion of the halogen-containing stream to produce a recovered halogen-containing stream. The recovering can occur after the contacting of the de-coked catalyst with the fluorine-containing stream, and contacting the de-coked catalyst with the recovered fluorine-containing stream.

In some embodiments at the end of the reactivation process, the catalyst can be reduced in a hydrogen rich atmosphere prior to returning to service. Adding a reducing gas, such as hydrogen, may remove some of the adsorbed halogen, such as chlorine. Thus, the reducing gas environment could possibly include hydrogen chloride desorbed from the metal surface. Despite this, halide can still accumulate on vessel walls and/or interior structures during the lifetime of the vessel, thereby impacting the integrity of the vessel.

In some embodiments, a specific procedure can be used to remove halide from a surface and/or in the wall structure of a vessel. In some aspects, a method can include contacting a catalyst with a halide within a vessel having a surface. Generally, at least a portion of the halide may be coupled to the surface. Afterwards, the catalyst can be reduced with a reducing fluid, such as a reducing gas, e.g., hydrogen, which, under proper conditions, may release the at least the portion of the halide coupled to the surface of the vessel. In some embodiments, a reducing fluid of hydrogen can remove up to about 10,500 parts per million (ppm) chloride from the surface inside a vessel, such as reactor walls, tubes, and/or other internal structures.

The residual metal halide or halide can be removed or the residual metal halide converted to metal in a quantifiable amount from the vessel wall surface. In some aspects, the halide portion of the metal halide is removed as a gas, such as hydrogen chloride or hydrogen fluoride, with the metal reverting to a reduced state, e.g., metal⁺ (M⁺) to M⁰. The reducing gas can include about 10 mol % to about 100 mol %, about 10 mol % to about 90 mol %, about 20 mol % to about 100 mol %, about 20 mol % to about 80 mol %, about 25 mol % to about 90 mol %, about 30 mol % to about 80 mol %, or about 35 mol % to about 70 mol % hydrogen and the balance nitrogen. Regenerating with the reducing gas can occur at least about 700° F., about 750° F., about 800° F., about 850° F., about 920° F., about 940° F., about 950° F., about 960° F., about 970° F., about 980° F., about 990° F., or about 1,000° F., preferably above about 930° F. The reducing of the regenerated catalyst with the reducing gas is at least about 2 hours, about 12 hours, about 24 hours, about 36 hours, about 48 hours, about 60 hours, or about 72 hours, or a time suitable depending on the vessel size and shape, flow rates, and residence times to desorb or otherwise remove the halide from the vessel surfaces. In some aspects, the vessel is purged with nitrogen prior to reducing.

Usually, a furnace can be in fluid communication with the vessel. As such, the furnace can be configured to provide a heated feed, optionally a reactant, to the vessel. In some embodiments, the halide can include a chloride, a fluoride, or a combination thereof, and the halide can be coupled to the surface and comprised in a metal halide.

In some aspects, the metal halide can include FeCl₃, FeCl₂, CrCl₃, CrCl₂, FeF₃, FeF₂, CrF₃, CrF₂, or a combination thereof, and the halide can be chloride, fluoride, bromide or a combination thereof. Although not wanting to be bound by theory, the halide can be bound to the surface inside the vessel by two mechanisms, such as by the formation of metal halides, e.g., FeCl₃ and the halide can be bound to a surface of the metal, e.g., surface chloride. The metal halide can be present at a depth of less than or equal to about 1, about 2, about 3, about 4, about 5, about 6, about 7, about 8, about 9, about 10, about 50, or about 100 microns. The surface can have a halide concentration of less than or equal to about 50,000 ppm, about 40,000 ppm, about 20,000 ppm, or about 10,000 ppm, as measured by energy dispersive spectroscopy (EDS).

Generally, the vessel containing the spent catalyst can be any suitable vessel, such as a reactor. In some embodiments, the reactor can be a radial flow reactor for reacting hydrocarbons, such as aromatization reactions. In some aspects, the reactor can include iron, chromium, nickel, aluminum, or a combination thereof, such as a stainless steel (SS), e.g., 347SS, 321SS, 316SS, or 304SS, in walls and/or internal supports. The reactor can include a protective coating on the stainless steel, and the protective coating can include tin; a stannide; titanium; aluminum; chromium; an oxide of tin, a stannide, titanium, aluminum, chromium, or a combination thereof, a nitride of tin, a stannide, titanium, aluminum, chromium, or a combination thereof, a carbide of tin, a stannide, titanium, aluminum, chromium, or a combination thereof, or a combination thereof. In some aspects, the protective coating comprises titanium nitride.

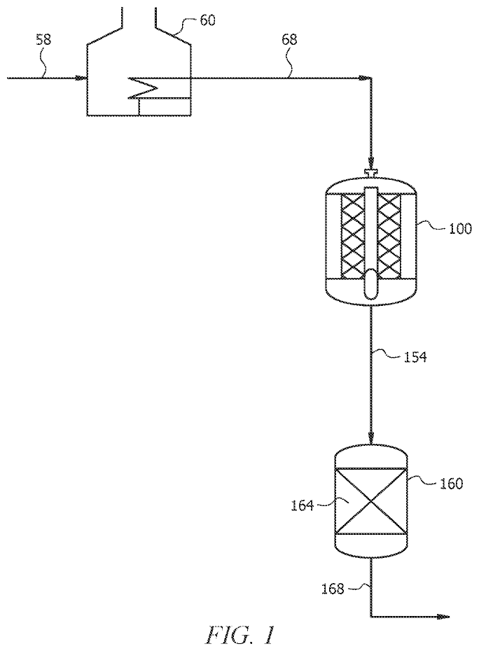

FIG. 1 depicts an exemplary scheme for processing a feed 58 including hydrocarbons, such as in some embodiments, during reforming operations. During maintenance and catalyst regeneration, the feed 58 may include or consist of other substances, typically in a gaseous state, including hydrogen, nitrogen, halogens including chlorine and fluorine, oxygen, a chlorofluorohydrocarbon, a fluorohydrocarbon, a fluorocarbon, or a combination thereof. In some aspects, the method or process can include a furnace 60, a vessel 100 and an absorber 160. Although only a single furnace 60, a single vessel 100, and a single absorber 160 are depicted, it should be understood that multiple furnaces and vessels may be used, arranged in any suitable order such as in series or parallel. In addition, other equipment may also be included, such as adsorbers and sorbers, compressors, exchangers, and flash drums, that are not depicted for simplifying the disclosure herein.

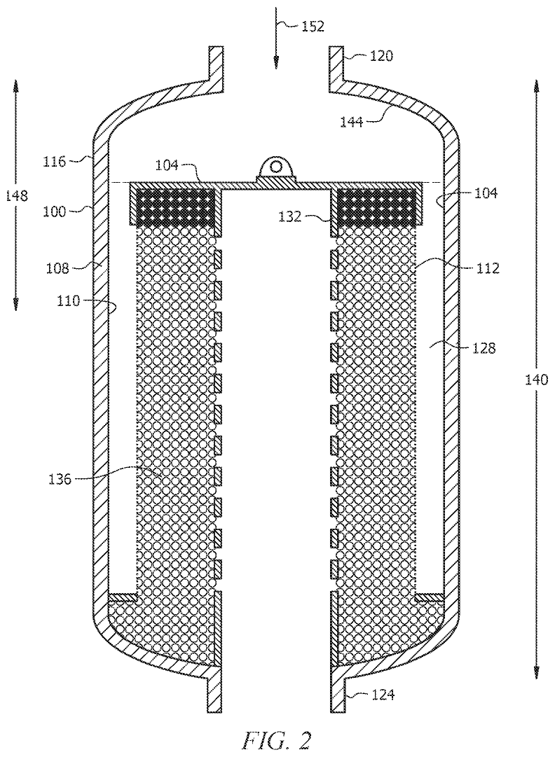

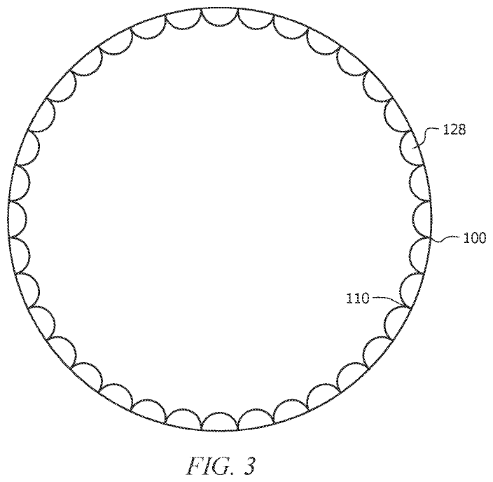

During manufacturing operations, a feed 58, in some embodiments including one or more hydrocarbons, can be provided to the furnace 60. Afterwards, a heated feed 68 can be provided to the vessel 100 for any suitable reaction, such as aromatization. The vessel 100 will be described in further detail hereinafter with reference to FIGS. 2-3. The vessel effluent 154 can be sent from the vessel 100 to any suitable destination, including to other equipment for additional processing.

After a period of time when the catalyst is spent, in some aspects the vessel effluent 154 during regeneration can be sent to an absorber 160, depending if an absorbent 164 is suitable to absorb halogens, remove halogens from the vessel effluent 154. The absorber effluent 168 can be sent to any suitable destination for further processing, recycling, or disposal.

Referring to FIGS. 2-3, the vessel 100 can form any suitable enclosure that may include a reactor 108 or a reactor system 108, including an aromatization reactor, e.g., a radial flow reactor 116, although the vessel 100 may be suitable for other processes besides aromatization. Although the vessel 100 is depicted as cylindrical, the vessel 100 can take any suitable shape, and the vessel 100 may be designed as top-flow, bottom-flow, or side-flow, although the depicted vessel 100 is designed for top-flow. In some embodiments, the vessel 100 can be a reactor 108 and fashioned from any suitable material, such as a metal, e.g., stainless steel, as discussed above. The vessel 100 (such as the reactor 108) can form an interior surface 104 (such as the interior wall surface 110) having a surface area. As depicted, the reactor 108 can be a radial flow reactor 116 with an inlet 120, an outlet 124, one or more scallops 128, and a center pipe 132. The radial flow reactor 116 may also include a plurality of reactor tubes 112 surrounding the center pipe 132. The interior wall surface (or wall) 110, the plurality of reactor tubes 112, the one or more scallops 128, and other internal structures of the vessel 100 can also be considered as providing all or part of the interior surface 104 having a surface area of the vessel 100. As depicted in FIGS. 2-3, the one or more scallops 128 can be spaced about the interior wall surface 110 of the vessel 100. The center pipe 132 can be surrounded by catalyst 136 inside the one or more scallops 128.

During regeneration, a halogen-containing fluid, such as a gas, can contact the catalyst in one or more separation applications. The halogen-containing gas can include chlorine, fluorine, a chloride, a fluoride, a fluorocarbon, or a combination thereof, and can be introduced over a series of steps with, e.g., one halogen-containing gas including chlorine and a subsequent halogen-containing gas including fluorine or a fluoride. The introduction of the halogen-containing gas or gases can react with metal surfaces of the vessel 100, including internal structures therein. In some embodiments, the halogens in the at least one halogen-containing gas entering the inlet 120 can substantially react with a surface 144 proximate to the inlet 120. In some embodiments, the amount of halide formed can be up to about 7,000 ppm halogen, such as 7,000 ppm chlorine. The reaction forms a metal halide at or in the surface 144 weakening the integrity of the vessel 100, particularly upon exposure to moisture. The vessel 100 can include a length 140, and “proximate to the inlet 120”, in some embodiments, can be generally about one-third length 148 of the length 140 of the vessel 100.

Referring to FIGS. 1-2, to release halide from one more surfaces inside the vessel 100, a reducing fluid 152 including any suitable fluid, such as a gas, may be introduced to the inlet 120. In some embodiments, the reducing fluid 152 can be hydrogen. Contacting the reducing fluid 152 with the interior surface 104 of the vessel 100 can release a halide gas, such as hydrogen chloride and/or hydrogen fluoride. The halide gas can exit the vessel 100 through the outlet 124. The reactor effluent 154 including the halide gas can be sent to the absorber 160 for removing the halide gas and to minimize its concentration in the absorber effluent 168. Removing the halides from the interior surface 104 can restore the integrity of the walls of the vessel 100 and extend the operational lifetime of the vessel 100. Although a hydrocarbon reactor has been discussed above, it should be understood that methods disclosed herein are applicable for any platform, vessel, apparatus, or process solving the problem of halide, such as chloride, corrosion.

### EXAMPLE

The embodiments having been generally described, the following examples are given as particular examples to demonstrate the practice and advantages of this disclosure. It is understood that the examples are given by way of illustration and are not intended to limit the specification or the claims in any manner.

A seventeen inch long reactor tube made from 321SS having a one inch outside diameter (OD) is loaded with 160 gram (g) of one-eighth inch diameter alumina spheres followed by 30 grams of spent platinum, chloride, and fluoride/L-zeolite catalyst and topped off with another 90 g of one-eighth inch diameter alumina spheres. The reactor is purged with nitrogen and the temperature is brought to 400° F., and then the temperature is held at 400° F. until the moisture is less than 10 ppm, by weight, water. Once stabilized, about 250 ppmv chlorine (Cl) gas is added for 180 minutes. The reactor is purged with nitrogen overnight at 400° F. Next, 0.5 mol % of oxygen is introduced, and the temperature is held at 400° F. for 30 minutes. Moisture and carbon dioxide are monitored using dragger tubes. The oxygen concentration is then increased to 3%, by mole, and the temperature is ramped to 850° F. and held for 3 hours. The temperature is then set at the value in Table 1 for the hydrochlorofluorocarbon material, which can typically sold under the trade designation FREON® by The Chemours Company FC, LLC of Wilmington, Delaware, addition. Once the temperature is stabilized, about 530 ppmv of 1,1,1,2-tetrafluoro ethane is introduced for 100 minutes. The temperature is then reduced to 500° F. in flowing 3 mol % oxygen in nitrogen and the catalyst is cooled to room temperature in pure nitrogen.

Next, a reduction step is performed for runs 2 and 4. The previous run is held at 500° F. in flowing nitrogen to sufficiently purge all the oxygen from the reactor. Hydrogen is introduced to yield a 50 mol % mixture with nitrogen and the temperature is ramped to 970° F. and held for 20 minutes. The reactor is then cooled to room temperature in a flowing mixture of 50 mol % hydrogen and 50 mol % nitrogen.

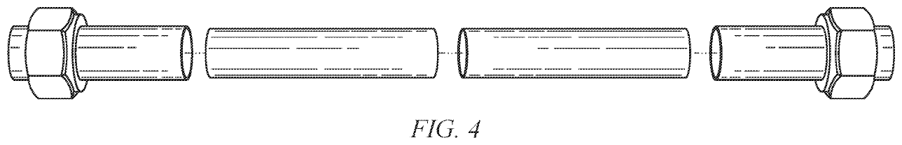

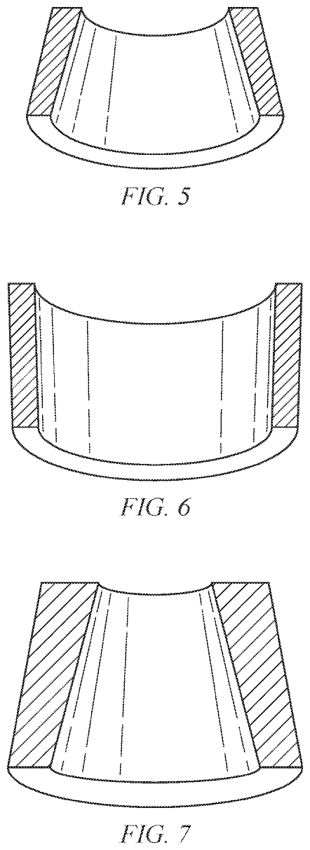

After each test the reactor tube is removed and sectioned into four parts, as depicted in FIG. 4. Portions of the removed tube as depicted in FIGS. 5, 6, and 7 are analyzed by Energy Dispersive Spectroscopy (EDS) for chlorine. A JEOL JSM-6610LV Scanning Electron Microscope (SEM) of Jeol, Ltd of Tokyo, Japan equipped with an Oxford Instruments INCA Energy 350 EDS system of Oxford Instruments plc of Abingdon, United Kingdom, including an 80 mm₂ area silicon drift detector (SDD), is used to determine the chlorine content. Multiple spots are averaged for the three metal portions: above the catalyst bed (FIG. 5), in the catalyst bed (FIG. 6), and below the catalyst bed (FIG. 7) and are reported in parts per million by weight (ppmw) in Table 1 below:

TABLE 1

| | Freon | | ppmw Cl by EDS | | |
|---|---|---|---|---|---|
| | addition | Reactivated | above | in | below |
| Run Number | temperature | Catalyst | catalyst | catalyst | catalyst |
| (No.) | ° F. | Reduced | bed | bed | bed |
| 1 | 730 | No | 2,500 | 1,100 | 2,100 |
| 2 | 730 | Yes | 1,825 | 430 | 100 |
| Difference | | | 675 | 670 | 2,000 |
| between Run | | | | | |
| No. 1 & 2 | | | | | |
| 3 | 850 | No | 6,750 | 10,400 | 6,000 |
| 4 | 850 | Yes | 360 | 0 | 730 |
| Difference | | | 6,390 | 10,400 | 5,270 |
| between Run | | | | | |
| No. 3 & 4 | | | | | |

The effect of the reduction on the chlorine adsorbed on the metallurgy can be determined by comparing Runs 1 to 2 and Runs 3 to 4. When the fluorination is performed at 730° F. (runs 1 and 2), a reduction ranging from 670 ppmw to 2,000 ppmw adsorbed chlorine is observed. When the fluorination is performed at 850° F. (runs 3 and 4), a reduction ranging from 5,270 ppmw to 10,400 ppmw adsorbed chlorine is observed. Thus showing that subjecting metallurgy with adsorbed halides, such as chlorides, to a reducing step decreases the concentration of the halides adsorbed on the surface.

### ADDITIONAL DESCRIPTION

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the detailed description of the present disclosure. The disclosures of all patents, patent applications, and publications cited herein are hereby incorporated by reference.

Aspects of a reducing fluid for releasing at least the portion of the halide coupled to the surface, as described above. The following are non-limiting, specific aspects in accordance with the present disclosure:

Aspect 1. A method comprises contacting a catalyst with a halide within a vessel 100 having a surface 104 wherein at least a portion of the halide is coupled to the surface 104, and regenerating the catalyst with a reducing fluid 152 to release the at least the portion of the halide coupled to the surface 104.

Aspect 2. The method of Aspect 1, further comprising a furnace 60 in fluid communication with the vessel 100, wherein the furnace 60 is configured to provide a heated feed 68, optionally a reactant, to the vessel 100.

Aspect 3. The method of Aspect 1 or 2, wherein the halide comprises a chloride, a fluoride, or a combination thereof.

Aspect 4. The method of any of Aspects 1 to 3, wherein the halide coupled to the surface 104 is comprised in a metal halide.

Aspect 5. The method of any of Aspects 1 to 4, wherein the metal halide comprises FeCl₃, FeCl₂, CrCl₃, CrCl₂, or a combination thereof.

Aspect 6. The method of any of Aspects 1 to 5, wherein the metal halide is present at a depth of less than or equal to about 1, about 2, about 3, about 4, about 5, about 6, about 7, about 8, about 9, about 10, about 50, or about 100 microns.

Aspect 7. The method of any of Aspects 1 to 6, wherein the halide comprises a chloride.

Aspect 8. The method of any of Aspects 1 to 7, wherein the halide comprises a fluoride.

Aspect 9. The method of any of Aspects 1 to 8, wherein the vessel 100 comprises a reactor 108, comprising an inlet 120, an outlet 124, one or more scallops 128 and a center pipe 132 surrounded by the catalyst, and the reactor 108 has a length 140, and the halide is coupled to a surface 104 proximate to the inlet 120.

Aspect 10. The method of Aspect 9, wherein about one-third 148 of the length 140 of the vessel 100 measured from the inlet 120 is proximate to the inlet 120.

Aspect 11. The method of Aspect 9 or 10, wherein the reactor 108 comprises a radial flow reactor 116.

Aspect 12. The method of any of Aspects 9 to 11, wherein the reactor 108 comprises stainless steel.

Aspect 13. The method of Aspect 12, wherein the stainless steel is selected from the group consisting of 347SS, 321SS, 316SS, and 304SS.

Aspect 14. The method of any of Aspects 9 to 13, wherein the reactor 108 comprises a protective coating on the stainless steel, and the protective coating comprises tin; a stannide;

titanium; aluminum; chromium; an oxide of tin, a stannide, titanium, aluminum, chromium, or a combination thereof, a nitride of tin, a stannide, titanium, aluminum, chromium, or a combination thereof; a carbide of tin, a stannide, titanium, aluminum, chromium, or a combination thereof; or a combination thereof.

Aspect 15. The method of Aspect 14, wherein the protective coating comprises titanium nitride.

Aspect 16. The method of any of Aspects 1 to 15, wherein the surface 104 has a halide concentration of less than or equal to about 50,000 ppm, about 40,000 ppm, about 20,000 ppm, or about 10,000 ppm, as measured by energy dispersive spectroscopy (EDS).

Aspect 17. The method of any of Aspects 1 to 16, wherein the reducing fluid 152 comprises a reducing gas.

Aspect 18. The method of Aspect 17, wherein the reducing gas comprises about 10 mol % to about 100 mol %, about 10 mol % to about 90 mol %, about 20 mol % to about 100 mol %, about 20 mol % to about 80 mol %, about 25 mol % to about 90 mol %, about 30 mol % to about 80 mol %, about 35 mol % to about 70 mol %, about 40 mol % to about 80 mol %, or about 50 mol % to about 70 mol % hydrogen and the balance nitrogen.

Aspect 19. The method of Aspect 17 or 18, wherein the regenerating with the reducing gas occurs at least about 700° F., about 750° F., about 800° F., about 850° F., about 920° F., about 940° F., about 950° F., about 960° F., about 970° F., about 980° F., about 990° F., or about 1,000° F., preferably above about 930° F.

Aspect 20. The method of any of Aspects 17 to 19, wherein the regenerating with the reducing gas is at least about 1 hour, about 2 hours, about 12 hours, about 24 hours, about 36 hours, about 48 hours, about 60 hours, or about 72 hours.

Aspect 21. The method of any of Aspects 1 to 20, wherein the vessel 100 is purged with nitrogen prior to regenerating.

Aspect 22. A method of removing all or a portion of a residual metal halide from a vessel wall surface 110, comprises contacting the vessel wall surface 110 comprising a first amount of the residual metal halide with a reducing fluid at least about 700° F. for at least about 1 hour to form a halide gas, and removing at least a portion of a halide from the residual metal halide from the vessel wall surface 110 to provide a second amount of the residual metal halide, wherein the second amount is less than the first amount.

Aspect 23. The method of Aspect 22, further comprising, prior to passing the reducing fluid, haliding a catalyst within a vessel 100 in communication with a furnace 60 and depositing at least a portion of the first amount of the residual metal halide.

Aspect 24. The method of claim 22 or 23, wherein a vessel wall 110 comprises iron.

Aspect 25. The method of any of Aspects 22 to 24, wherein a vessel wall 110 comprises iron, chromium, and nickel.

Aspect 26. The method of any of Aspects 22 to 25, wherein the halide comprises chloride, fluoride, bromide, or a combination thereof.

Aspect 27. The method of any of Aspects 22 to 26, wherein the halide comprises chloride.

Aspect 28. The method of any of Aspects 22 to 27, wherein the halide comprises fluoride.

Aspect 29. The method of any of Aspects 22 to 28, wherein the metal halide comprises FeCl₃, FeCl₂, CrCl₃, CrCl₂, or a combination thereof.

Aspect 30. The method of any of Aspects 22 to 29, wherein the metal halide comprises FeF₃, FeF₂, CrF₃, CrF₂, or a combination thereof.

Aspect 31. The method of any of Aspects 22 to 30, wherein the reducing fluid comprises hydrogen.

Aspect 32. The method of any of Aspects 22 to 31, wherein the residual metal halide is removed in a quantifiable amount from the vessel wall surface 110.

Aspect 33. The method of any of Aspects 22 to 32, wherein a vessel 100 comprises a reactor 108 wherein the vessel wall surface 110 comprises a reactor wall surface 110.

Aspect 34. The method of any of Aspects 23 to 33, wherein the catalyst, prior to contacting, comprises at least one metal of IUPAC Groups 8-11, at least one halide, and a support.

Aspect 35. The method of Aspect 34, wherein the at least one metal comprises platinum, the at least one halide comprises chloride, fluoride, or a combination thereof, and the support comprises a zeolite, an L-zeolite, a bound zeolite base, or a combination thereof.

Aspect 36. The method of Aspect 34 or 35, wherein the support comprises the bound zeolite base, such as a bound L-zeolite.

Aspect 37. The method of Aspect 36, wherein the bound L-zeolite comprises a bound barium ion-exchanged L-zeolite.

Aspect 38. The method of Aspect 36 or 37, wherein the bound zeolite base comprises a silica-bound K/L-zeolite.

Aspect 39. The method of any of Aspects 34 to 38, wherein the at least one halide comprises chloride and fluoride.

Aspect 40. The method of any of Aspects 23 to 39, wherein the catalyst comprises from about 0.3 wt. % to about 3 wt. %, from about 0.5 wt. % to about 2.5 wt. %, from about 0.5 wt. % to about 2 wt. %, or from about 0.7 wt. % to about 1.5 wt. % platinum; from about 0.1 wt. % to about 7.0 wt. %, from about 0.2 wt. % to about 6.0 wt. %, from about 0.3 wt. % to about 5.0 wt. %, from about 0.4 wt. % to about 4.5 wt. %, from about 0.5 wt. % to about 4.0 wt. %, from about 0.6 wt. % to about 3.5 wt. %, from about 0.7 wt. % to about 3.0 wt. %, from about 0.8 wt. % to about 2.5 wt. %, from about 0.3 wt. % to about 1.5 wt. %, from about 0.4 wt. % to about 1.2 wt. %, from about 0.5 wt. % to about 1.1 wt. %, from about 1.5 wt. % to about 5 wt. %, from about 1.7 wt. % to about 4.5 wt. %, or from about 1.8 wt. % to about 4 wt. % chlorine; and from about 0.2 wt. % to about 1.5 wt. %, from about 0.25 wt. % to about 1.3 wt. %, from about 0.3 wt. % to about 1.1 wt. %, or from about 0.3 wt. % to about 1.0 wt. % fluorine; all based on a total weight of the supported, fresh catalyst, optionally reduced.

Aspect 41. The method of any of Aspects 35 to 40, wherein the bound zeolite base comprises a silica-bound K/L-zeolite; the metal comprises platinum; and a weight ratio of chlorine:fluorine is in a range from about 0.5:1 to about 5:1.

Aspect 42. The method of any of Aspects 22 to 41, wherein the vessel wall surface 110 reacts with a halogen during halogenation of the catalyst.

Aspect 43. The method of any of Aspects 22 to 42, wherein the halide gas comprises hydrogen chloride.

Aspect 44. The method of any of Aspects 22 to 43, further comprising, prior to introducing the reducing fluid, contacting a catalyst with a halide-containing fluid comprising a halide-containing compound in a gas phase to produce a halided catalyst and a halided vessel wall surface 110.

Aspect 45. The method of any of Aspects 22 to 44, further comprising passing the halide gas through an absorbent 164 downstream of a vessel 100.

Aspect 46. A method, comprises contacting a hydrocarbon feed with an aromatization catalyst comprising a transition metal and a catalyst support under reforming conditions in a metal reactor 108 to produce an aromatic product; performing contacting for a time period sufficient to form spent aromatization catalyst; stopping contacting with the hydrocarbon feed; stripping with hydrogen; purging with nitrogen; halogenating with a first halide a spent aromatization catalyst; purging with nitrogen; oxidating at a temperature less than or equal to about 400° F.; oxidating at a temperature greater than or equal to about 400° F. and less than or equal to about 850° F. or less than or equal to about 1,000° F.; halogenating with a second halide the spent aromatization catalyst; purging with a gas comprising oxygen; cooling the metal reactor 108 to less than or equal to 500° F.; purging with nitrogen; and reducing with a reducing fluid to remove a metal halide from a metal reactor wall surface 110.

Aspect 47. A method, comprises contacting an interior surface 104, optionally metal, or an interior metal surface area of a reactor vessel 100 or a reactor system 108 with a halide or a halide-containing compound, wherein at least a portion of the halide is coupled to the interior surface 104; and releasing at least the portion of the halide coupled to the interior surface 104 via contact with hydrogen in an amount effective to protect the vessel integrity.

Aspect 48. The method of Aspect 47, further comprising a furnace 60 in fluid communication with the reactor vessel 100 or the reactor system 108, wherein the furnace 60 is configured to provide a heated feed 68, optionally a reactant, to the reactor vessel 100 or the reactor system 108.

Aspect 49. The method of Aspect 47 or 48, wherein the halide comprises a chloride, a fluoride, or a combination thereof.

Aspect 50. The method of any of Aspects 47 to 49, wherein the halide coupled to the surface 104 is comprised in a metal halide.

Aspect 51. The method of any of Aspects 47 to 50, wherein the metal halide comprises FeCl₃, FeCl₂, CrCl₃, CrCl₂, or a combination thereof.

Aspect 52. The method of Aspect 50 or 51, wherein the metal halide is present at a depth of less than or equal to about 1, about 2, about 3, about 4, about 5, about 6, about 7, about 8, about 9, about 10, about 50, or about 100 microns.

Aspect 53. The method of any of Aspects 47 to 52, wherein the halide or the halide-containing compound comprises a chloride.

Aspect 54. The method of any of Aspects 47 to 53, wherein the halide or the halide-containing compound comprises a fluoride.

Aspect 55. The method of any of Aspects 47 to 54, wherein the reactor vessel 100 or reactor system 108 comprises a reactor 108, comprising an inlet 120, an outlet 124, one or more scallops 128 and a center pipe 132 surrounded by the catalyst, and the reactor 108 has a length, and the halide is coupled to a surface proximate to the inlet 120.

Aspect 56. The method of Aspect 55, wherein about one-third of the length 148 of the reactor 108 measured from the inlet 120 is proximate to the inlet 120.

Aspect 57. The method of Aspect 55 or 56, wherein the reactor 108 comprises a radial flow reactor 116.

Aspect 58. The method of any of Aspects 47 to 57 wherein a catalyst is disposed within the reactor vessel 100 or the reactor system 108.

Aspect 59. The method of Aspect 58 wherein the catalyst is an aromatization catalyst.

Aspect 60. The method of Aspect 59 wherein the aromatization catalyst, prior to contacting, comprises at least one metal of IUPAC Groups 8-11, at least one halide, and a support and the halide is chloride gas.

Aspect 61. The method of any of Aspects 47 to 60, wherein the releasing occurs at least about 700° F., about 750° F., about 800° F., about 850° F., about 920° F., about 940° F., about 950° F., about 960° F., about 970° F., about 980° F., about 990° F., or about 1,000° F., preferably above about 930° F.

Aspect 62. The method of any of Aspects 47 to 61, wherein the releasing is at least about 2 hours, about 12 hours, about 24 hours, about 36 hours, about 48 hours, about 60 hours, or about 72 hours.

Aspect 63. The method of any of Aspects 47 to 62 wherein releasing is carried out at a temperature of at least about 700° F., or about 970° F. for a time of at least about 2 hours or at least about 24 hours, preferably about 700° F. for at least about 24 hours or about 970° F. for at least about 12 hours.

Aspect 64. The method of any of Aspects 55 to 63 wherein the reactor 108 comprises a plurality of reactor tubes 112 providing the interior surface 104 or the interior surface area.

Aspect 65. The method of any of Aspects 55 to 64 wherein the reactor 108 comprises a reactor metal comprising one or more metals, comprising iron, chromium, nickel, or a combination thereof.

Aspect 66. The method of any of Aspects 55 to 65, wherein the reactor 108 comprises stainless steel.

Aspect 67. The method of Aspect 66, wherein the stainless steel is selected from the group consisting of 347SS, 321SS, 316SS, and 314SS.

Aspect 68. The method of any of Aspects 47 to 67, wherein the interior surface 104 has a halide concentration of less than or equal to about 50,000 ppm, about 40,000 ppm, about 20,000 ppm, or about 10,000 ppm, as measured by energy dispersive spectroscopy (EDS).

Aspect 69. A method of regenerating a spent catalyst comprising a transition metal and a catalyst support in a metal reactor 108, the method comprises (1) contacting the spent catalyst with a chlorine-containing stream comprising a chloride-containing compound to produce a chlorinated spent catalyst; (2) contacting the chlorinated spent catalyst with a decoking gas stream comprising oxygen to produce a de-coked catalyst; (3) contacting the de-coked catalyst with a fluorine-containing stream comprising a fluoride-containing compound to produce a regenerated catalyst, wherein the fluoride-containing compound comprises a hydrofluorocarbon (HFC), a chlorofluorocarbon (CFC), a hydrochlorofluorocarbon (HCFC), or a combination thereof; wherein the contacting (1), the contacting (2), or both yield a residual halide on an interior surface 104 or interior surface area of the metal reactor 108, and (4) removing at least the portion of the residual halide via contact with hydrogen.

Aspect 70. A method of regenerating a spent catalyst comprising a transition metal and a catalyst support in a metal reactor 108, the method comprises (1) contacting the spent catalyst with a chlorine-containing stream comprising a chloride-containing compound to produce a chlorinated spent catalyst; (2) contacting the chlorinated spent catalyst with a decoking gas stream comprising oxygen to produce a de-coked catalyst; (3) contacting the de-coked catalyst with a fluorine-containing stream comprising a fluoride-containing compound to produce a regenerated catalyst, wherein the fluoride-containing compound comprises a hydrofluorocarbon (HFC), a chlorofluorocarbon (CFC), a hydrochlorofluorocarbon (HCFC), or a combination thereof, wherein the contacting (1), the contacting (2), or both yield a residual halide on an interior surface 104 or interior surface area of the metal reactor 108, and (4) contacting the residual halide with hydrogen under conditions effective for the removal of at least a portion of the residual halide from the interior surface 104 or the interior surface area.

Aspect 71. A reforming method comprises (A) contacting a hydrocarbon feed with an aromatization catalyst including a transition metal and a catalyst support under reforming conditions in a metal reactor system to produce an aromatic product; (B) performing step (A) for a time period sufficient to form a spent catalyst; (C) contacting the spent catalyst with a chlorine-containing stream including a chlorine-containing compound to produce a chlorinated spent catalyst, (D) contacting the chlorinated spent catalyst with a decoking gas stream including oxygen to produce a de-coked catalyst; and (E) contacting the de-coked catalyst with a fluorine-containing stream including a fluorine-containing compound, wherein the fluorine-containing compound comprises a hydrofluorocarbon (HFC), a fluorocarbon (FC), a chlorofluorocarbon (CFC), a hydrochlorofluorocarbon (HCFC), or a combination thereof.

Aspect 72. The method of Aspect 71, further comprises reactivating the catalyst after step (E).

Aspect 73. The method of Aspects 71 or 72, wherein the reforming method is an in situ process, for example, steps (A)-(E) are performed in the same reactor system.

Aspect. 74. The method of any of Aspects 71 to 73, wherein the steps (C)-(E) are performed externally to the reactor system of steps (A)-(B), for example, steps (C)-(E) are performed in a metal reactor that is not in the reforming reactor system.

While preferred embodiments of the invention have been shown and described, modifications thereof can be made by one skilled in the art without departing from the teachings of this disclosure. The embodiments described herein are exemplary only, and are not intended to be limiting. Many variations and modifications of the invention disclosed herein are possible and are within the scope of the invention.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
contacting a catalyst with a halide within a vessel having a surface wherein at least a portion of the halide is coupled to the surface; and
regenerating the catalyst with a reducing fluid to release the at least the portion of the halide coupled to the surface.

2. The method of claim 1, further comprising a furnace in fluid communication with the vessel, wherein the furnace is configured to provide a heated feed, optionally a reactant, to the vessel.

3. The method of claim 1, wherein the halide comprises a chloride, a fluoride, or a combination thereof.

4. The method of claim 3, wherein the halide coupled to the surface is comprised in a metal halide.

5. The method of claim 4, wherein the metal halide comprises FeCl₂, FeCl₃, CrCl₂, CrCl₂, or a combination thereof.

6. The method of claim 4, wherein the metal halide is present at a depth of less than or equal to about 100 microns.

7. The method of claim 1, wherein the halide comprises a chloride.

8. The method of claim 1, wherein the vessel comprises a reactor, comprising an inlet, an outlet, one or more scallops and a center pipe surrounded by the catalyst, and the reactor has a length, and the halide is coupled to a surface proximate to the inlet.

9. The method of claim 8, wherein about one-third of the length of the vessel measured from the inlet is proximate to the inlet.

10. The method of claim 8, wherein the reactor comprises a stainless steel.

11. The method of claim 10, wherein the reactor comprises a protective coating on the stainless steel, and the protective coating comprises tin; a stannide; titanium; aluminum; chromium; an oxide of tin, a stannide, titanium, aluminum, chromium, or a combination thereof, a nitride of tin, a stannide, titanium, aluminum, chromium, or a combination thereof, a carbide of tin, a stannide, titanium, aluminum, chromium, or a combination thereof, or a combination thereof.

12. The method of claim 1, wherein the surface has a halide concentration of less than or equal to about 50,000 ppm, as measured by energy dispersive spectroscopy (EDS).

13. The method of claim 1, wherein the reducing fluid comprises a reducing gas.

14. The method of claim 13, wherein the reducing gas comprises about 10 mole percent to about 100 mole percent hydrogen, and balance nitrogen.

15. The method of claim 14, wherein the regenerating with the reducing gas occurs at about 500° F. to about 1,300° F., and at least about 2 hours.

16. A method of removing all or a portion of a residual metal halide from a vessel wall surface, comprising:
contacting the vessel wall surface comprising a first amount of the residual metal halide with a reducing fluid at about 500° F. to about 1,300° F., and at least about 1 hour to form a halide gas, and
removing at least a portion of a halide from the residual metal halide from the vessel wall surface to provide a second amount of the residual metal halide, wherein the second amount is less than the first amount.

17. The method of claim 16, further comprising, prior to passing the reducing fluid, haliding a catalyst within a vessel in communication with a furnace and depositing at least a portion of the first amount of the residual metal halide.

18. The method of claim 16, wherein a vessel wall comprises iron.

19. The method of claim 17, wherein the catalyst, prior to contacting, comprises at least one metal of IUPAC Groups 8-11, at least one halide, and a support.

20. A method, comprising:
contacting an interior surface, optionally metal, of a reactor vessel with a halide or a halide-containing compound, wherein at least a portion of the halide is coupled to the interior surface; and releasing at least the portion of the halide coupled to the interior surface via contact thereof with hydrogen in an amount effective to protect the vessel integrity.
